(19) United States
(12) Patent Application Publication
(10) Pub. No.: US 2011/0244312 A1
(43) Pub. Date: Oct. 6, 2011

(54) STACK TYPE BATTERY

(75) Inventors: Yuji TANI, Sumoto-shi (JP); Hitoshi MAEDA, Sumoto-shi (JP); Yoshitaka SHINYASHIKI, Kobe-shi (JP); Masayuki FUJIWARA, Kasai-shi (JP); Atsuhiro FUNAHASHI, Osaka (JP)

(73) Assignee: SANYO ELECTRIC CO., LTD., Osaka (JP)

(21) Appl. No.: 13/073,462

(22) Filed: Mar. 28, 2011

(30) Foreign Application Priority Data
Mar. 30, 2010 (JP) 2010-079161

(51) Int. Cl. H01M 2/00; H01M 4/02

(52) U.S. Cl. 429/163

(57) ABSTRACT

In a stack type battery, stacked positive and negative electrode lead tabs (11, 12) are joined to one another at a location between the current collector terminals and the electrode plates, the positive and negative electrode lead tabs (11, 12) being folded at an intermediate location between positive and negative electrode current collector terminals (15, 16) and positive and negative electrode plates and protruding from the positive and negative electrode plates. A stacked electrode assembly (10) is accommodated in a battery case (18) having flexibility. A first spacer (a first cover portion (52) of an integral-type spacer (5)) is disposed between the battery case (18) and an open side end of the positive and negative electrode lead tabs (11, 12) formed by folding the positive and negative electrode lead tabs (11, 12).

### BACKGROUND OF THE INVENTION

1. Field of the Invention

The present invention relates to stack type batteries used for, for example, robots, electric vehicles, and backup power sources. More particularly, the invention relates to a stack type battery that can accommodate the battery components in a compact manner and at the same time can inhibit the battery case from creases or warpage during vacuum-sealing.

2. Description of Related Art

When producing a stack type battery in which a stacked electrode assembly is accommodated in a laminate battery case having flexibility, it has conventionally been common practice to seal the battery case while evacuating the inside of the battery case (i.e., to perform vacuum-sealing), in order to infiltrate the electrolyte solution sufficiently into the electrode assembly. In this process, a gap tends to form easily between the electrode assembly and the battery case, particularly at the portion from which the current collectors protrude, and at the location where the gap is formed, creases and warpage tend to form in the battery case because of the internal pressure change resulting from the evacuation.

In view of the problem, a spacer is disposed at a portion where the gap is formed between the electrode assembly and the battery case for the purposes of, for example, preventing the creases and warpage, as disclosed in Japanese Published Unexamined Patent Application Nos. 2005-317312, 2008-262788, and 2000-311665.

In a stack type battery, a plurality of electrode plate lead tabs protruding from the respective electrode plates are joined respectively to positive and negative electrode current collector terminals by ultrasonic welding so as to be stacked and overlapped with one another. In the case of a stack type battery that has a high capacity and needs to be charged and discharged at high rate, the number of the stacks tends to be larger in order to achieve a high capacity, and the thickness of the current collector terminals tends to be greater in order to pass a large current therethrough. This necessitates ultrasonic welding of a large number of electrode plate lead tabs each made of metal foil to the current collector terminal made of a thick metal plate. However, in this case, weldability of the welded portions between the metal foils and the metal plate tends to be poorer than that of the welded portions of the metal foils to each other, because of their thickness difference. When the weldability becomes poor, the connection resistance between each of the electrode plates and the current collector terminal becomes non-uniform, causing variations in the current values flowing into the respective electrode plates especially when used at high rate. As a consequence, uneven charge-discharge states arise in the battery, causing overdischarge and overcharge partially. Consequently, the cycle performance of the battery deteriorates.

In view of the problem, Japanese Published Unexamined Patent Application No. 2009-87611 discloses (Patent Document 4) that, in addition to joining the electrode plate lead tabs to the current collector terminals, the stacked electrode plate lead tabs are joined to one another by ultrasonic welding or the like at a location between the current collector terminals and the electrode plates, in other words, at a location where only the electrode plate lead tabs exist, to thereby uniformize the connection resistance between the electrode plates and the current collector terminals and inhibit variations of the current values flowing into the electrode plates. (In the present specification, this type of connection structure is also referred to as a “two-stage connection structure”).

In the stack type battery, especially in the stack type battery that requires a high capacity charge and discharge, the stacked electrode assembly needs to be accommodated the battery case in as efficient manner as possible, in order to obtain a high energy density. However, when the above-described two-stage connection structure is employed, a portion in which only the electrode plate lead tabs are joined needs to be provided between the current collector terminals and the electrode plates, and correspondingly, the length of the electrode plate lead tabs inevitably becomes long. Accordingly, the space occupied by the electrode plate lead tabs in the battery becomes large, and the volumetric energy density of the battery lowers. To solve this problem in the above-described two-stage connection structure, the following structure is employed. The electrode plate lead tabs are bent in a hook-like shape viewed from side so as to extend in a direction substantially perpendicular to the originally extending direction (in other words, so as to extend in a thickness direction), then bent backward at the extending end, and again bent in a perpendicular direction so as to extend in the originally extending direction. Thereby, the electrode plate lead tabs as a whole are shortened with respect to the extending direction by folding them at an intermediate location along the extending direction, to prevent the electrode plate lead tabs from occupying a large space. (In the present specification, this type of bending structure of the electrode plate lead tabs is also referred to as a “folding structure”.)

The present inventors have newly found that when the battery case is vacuum-sealed as described above in the case of employing the above-described two-stage connection structure and accordingly employing the folding structure for the electrode plate lead tabs, the laminate battery case is forced into the folded electrode plate lead tabs such as to force open the folded electrode plate lead tabs and as a consequence, creases are formed at that location in such a way that the battery case is dented inward. More specifically, when employing the folding structure of the electrode plate lead tabs, the folded portion is allowed to open in a V-shape as viewed from side. Therefore, even if the electrode plate lead tabs are folded so as to be in close contact with one another without any gap, the pressure reduction causes the battery case to force open a portion of the electrode plate lead tabs that can be unfolded and come into the gap formed at that portion. Consequently, the battery case is dented inward. That is, by the pressure reduction, the battery case is forced into a fold position of the electrode plate lead tabs where there was originally no gap, and thereby a gap is formed. As a consequence, creases in the battery case develop at that position.

### BRIEF SUMMARY OF THE INVENTION

It is an object of the present invention to provide a stack type battery that can effectively prevent creases or warpage formed in the battery case during vacuum-sealing in the case that the battery is constructed using a battery case having flexibility.

In one aspect of the invention, the present invention provides a stack type battery, comprising:

a stacked electrode assembly having a plurality of positive electrode plates, a plurality of negative electrode plates, and a separator interposed therebetween, the positive electrode plates and the negative electrode plates being alternately stacked on one another;

a plurality of electrode plate lead tabs protruding from the respective electrode plates, the electrode plate lead tabs stacked and overlapped with one another and joined respectively to positive and negative electrode current collector terminals,

the stacked electrode plate lead tabs being joined to one another at a location between the current collector terminals and the electrode plates, and

the electrode plate lead tabs being folded at an intermediate location and protruding from the respective electrode plates;

a battery case having flexibility and accommodating the stacked electrode assembly therein; and

a first spacer disposed between the battery case and an open side end of the electrode plate lead tabs, the open side end being located opposite a fold line side end and formed by folding back the electrode plate lead tabs at least one time.

In another aspect of the invention, the present invention also provides a stack type battery comprising:

a stacked electrode assembly having a plurality of positive electrode plates, a plurality of negative electrode plates, and a separator interposed therebetween, the positive electrode plates and the negative electrode plates being alternately stacked on one another;

a plurality of electrode plate lead tabs protruding from the respective electrode plates, the electrode plate lead tabs stacked and overlapped with one another and joined respectively to positive and negative electrode current collector terminals,

a battery case having flexibility and accommodating the stacked electrode assembly therein; and

a spacer disposed between the electrode plate lead tabs and the battery case,

the spacer having an overlapping portion overlapping with a peripheral portion of the stacked electrode assembly for compensating a thickness of the stacked electrode assembly.

The present invention makes it possible to effectively prevent a stack type battery constructed using a battery case having flexibility from creases or warpage formed in the battery case during vacuum-sealing.

### BRIEF DESCRIPTION OF THE DRAWINGS

FIG. 1 shows portions of a stack type battery according to the present invention, wherein FIG. 1(a) is a plan view illustrating a positive electrode thereof, FIG. 1(b) is a perspective view illustrating a separator thereof, and FIG. 1(c) is a plan view illustrating a pouch-type separator thereof in which the positive electrode is disposed;

FIG. 2 is a plan view illustrating a negative electrode plate used for the stack type battery of the present invention;

FIG. 3 is an exploded perspective view illustrating a stacked electrode assembly used for the stack type battery according to the present invention;

FIG. 4 is a plan view illustrating the stacked electrode assembly used for the stack type battery according to the present invention;

FIG. 5 is a perspective view illustrating how positive and negative electrode lead tabs and positive and negative electrode current collector terminals are welded;

FIG. 6 is a side view illustrating how the positive and negative electrode lead tabs are bent;

FIG. 7 is a perspective view illustrating spacers used for the stack type battery of the present invention;

FIG. 8 is a perspective view illustrating how the spacers are disposed in the stacked electrode assembly used for the stack type battery according to the present invention;

FIG. 9 is a side view illustrating how the spacers are disposed in the stacked electrode assembly used for the stack type battery according to the present invention;

FIG. 10 is a perspective view illustrating how a stacked electrode assembly is inserted in a battery case used for the stack type battery according to the present invention;

FIG. 11 is a schematic cross-sectional view illustrating how the stacked electrode assembly is inserted in a battery case used for the stack type battery according to the present invention;

FIG. 12 is a perspective view illustrating a first spacer and a second spacer used for the stack type battery according to another embodiment;

FIG. 13 is a partially cut-away schematic side view illustrating how a stacked electrode assembly according to another embodiment is inserted in a battery case; and

FIG. 14 is a partial schematic cross-sectional view illustrating a stack type battery in which an integral type spacer according to another embodiment is disposed in the stacked electrode assembly.

### DETAILED DESCRIPTION OF THE INVENTION

A stack type battery according to the present invention may comprise: a stacked electrode assembly having a plurality of positive electrode plates, a plurality of negative electrode plates, and a separator interposed therebetween, the positive electrode plates and the negative electrode plates being alternately stacked on one another; a plurality of electrode plate lead tabs protruding from the respective electrode plates, the electrode plate lead tabs stacked and overlapped with one another and joined respectively to positive and negative electrode current collector terminals, the stacked electrode plate lead tabs being joined to one another at a location between the current collector terminals and the electrode plates, and the electrode plate lead tabs being folded at an intermediate location and protruding from the respective electrode plates; a battery case having flexibility and accommodating the stacked electrode assembly therein; and a first spacer disposed between the battery case and an open side end of the electrode plate lead tabs, the open side end being located opposite a fold line side end and formed by folding back the electrode plate lead tabs at least one time.

In the present invention, the electrode plate lead tabs may be folded at an intermediate location of their protruding portion by any kind of method, as long as it is possible to a structure in which a fold line end and an open end that is opposite thereto are formed by folding them back at least one time. For example, the electrode plate lead tabs may be bent in a hook-like shape viewed from side so as to extend in a direction substantially perpendicular to the originally extending direction (in other words, so as to extend in a thickness direction), then bent backward at the extending end, and again bent in a perpendicular direction so as to extend in the originally extending direction, as described above. In addition, the same folding operation described above may be repeated two or more times so as to form a zigzag fold.

The spacer may be made of any type of material as long as it can keep its shape even under the internal pressure change due to the vacuum-sealing of the battery case. Examples include rubber and resin, such as polypropylene (PP) and polyethylene (PE). In the present invention, the term “spacer” means to include any of the following: one for keeping a gap or interval at a constant value, one for filling a gap, and one for preventing formation of a gap or an interval in advance.

With the above-described configuration of the present invention, the first spacer disposed between the battery case and the open side end of the electrode plate lead tabs prevents the battery case from being forced into the open side ends of the electrode plate lead tabs that have been formed by folding them back at least one time because of the pressure reduction in the vacuum-sealing of the battery case, so the battery case is unable to gets into the open side ends of the electrode plate lead tabs. As a result, the battery case cannot be dented inward at that portion. Therefore, formation of creases and warpage is inhibited.

In addition, the formation of creases or warpage in the battery case can be inhibited effectively by the simple structure of providing the first spacer between the battery case and the open side ends of the electrode plate lead tabs. This means that the battery structure is not made more complicated.

It is desirable that the first spacer be disposed so as to be inserted between the open side ends of the electrode plate lead tabs.

A gap may be easily formed between the open side ends of the electrode plate lead tab formed by folding them back at least one time when they are forced open as described above. However, the above-described configuration makes it possible to inhibit formation of a gap at this portion more effectively because the first spacer is inserted in advance at the open side ends. In other words, the gap that can be formed at the open side ends of the electrode plate lead tabs is filled in advance by the first spacer, so that the formation of the gap is inhibited more effectively.

It is desirable that the stack type battery further comprise a second spacer disposed opposite the first spacer across the electrode plate lead tabs.

The location opposite the first spacer across the electrode plate lead tabs is a location serving as the portion from which the current collectors protrude, and a location in which a gap can be easily formed, as described above. By providing the second spacer at this location, formation of creases or warpage in the battery case can be inhibited more effectively.

In addition, the opening of the electrode plate lead tabs is prevented by not only by the first spacer but also by the second spacer from the opposite side. As a result, the creases or warpage of the battery case can be inhibited even more effectively. In other words, the opening of the electrode plate lead tabs is prevented mainly by the first spacer and also additionally by the second spacer.

It is desirable that the second spacer have an overlapping portion overlapping with a peripheral portion of the stacked electrode assembly for compensating a thickness of the stacked electrode assembly.

In the stacked electrode assembly, the positive electrode plates are formed in a smaller size than the negative electrode plates, so the positive electrode plates do not exist in the peripheral portion of the stacked electrode assembly. Thus, the peripheral portion of the stacked electrode assembly is thinner than the more inward portion thereof by the thickness of the positive electrode plates. For this reason, when vacuum-sealing the battery case, the battery case can deform in such a way as to be dented inward by the pressure reduction (i.e., in such a way as to form a step), and creases and warpage tend to form easily also at the peripheral portion of the stacked electrode assembly. By providing the overlapping portion for the second spacer, insufficient thickness in the peripheral portion of the stacked electrode assembly is compensated, and thereby, the battery case is prevented from deforming in such a way as to be dented inward.

It is desirable that the first spacer and the second spacer be integrated with each other.

In the present invention, the phrase “the first spacer and the second spacer are integrated with each other” may mean to include both of a configuration in which the first spacer and the second spacer are formed integrally by integral formation and a configuration in which the first spacer and the second spacer that have been formed individually are integrated by joining them to each other by an appropriate method such as welding, molding, and screw-fastening.

When the first spacer and the second spacer are separated and disposed individually, the positions of the first spacer and the second spacer tend to be misaligned easily due to the internal pressure changes caused by vacuum-sealing and the shock caused by dropping. This misalignment is likely to be a cause of the creases or warpage of the battery case. However, when the first spacer and the second spacer are integrated with each other as described above, such misalignment does not occur easily.

It is desirable that the spacer (the first spacer and/or the second spacer) be electrically insulative.

As already described above, it is desirable that the spacer be made of a material having insulative properties, such as rubber and resin. The use of rubber or resin allows the spacer to be formed into a desirable hardness, makes the processing easy, and moreover, enables formation of the spacers for the positive and negative electrodes integrally.

It is desirable that the spacer have a Vickers hardness of from 100 HV to less than 200 HV.

The shape-retaining capability of the spacer can be sufficiently exhibited when the spacer has a Vickers hardness of 100 HV or greater, although it may depend on its shape and thickness. When the spacer has a Vickers hardness of less than 200 HV, the battery case can be prevented from being damaged by the corner portions or the like of the battery case during the vacuum-sealing because of excessive hardness, and moreover, the spacer can be easily fitted or mounted because it can be deformed to an appropriate degree. In particular, when the first spacer and the second spacer are integrated with each other, fitting or mounting of the spacer tends to be difficult if the deformability of the spacer is insufficient. Therefore, setting the hardness at less than 200 HV is especially effective in such cases.

In a second aspect, the present invention also provides a stack type battery comprising: a stacked electrode assembly having a plurality of positive electrode plates, a plurality of negative electrode plates, and a separator interposed therebetween, the positive electrode plates and the negative electrode plates being alternately stacked on one another; a plurality of electrode plate lead tabs protruding from the respective electrode plates, the electrode plate lead tabs stacked and overlapped with one another and joined respectively to positive and negative electrode current collector terminals, a battery case having flexibility and accommodating the stacked electrode assembly therein; and a spacer disposed between the electrode plate lead tabs and the battery case, the spacer having an overlapping portion overlapping with a peripheral portion of the stacked electrode assembly for compensating a thickness of the stacked electrode assembly.

With the configuration of the second aspect of the invention, the spacer is disposed between the battery case and the electrode plate lead tabs. As a result, the battery case is prevented from being dented inward, and thereby, formation of creases or warpage in the battery case is inhibited. Moreover, since the spacer has the overlapping portion, formation of the creases or warpage of the battery case is prevented also at the peripheral portion of the stacked electrode assembly.

In the stacked electrode assembly, the positive electrode plates are formed in a smaller size than the negative electrode plates, so the positive electrode plates do not exist in the peripheral portion of the stacked electrode assembly. Thus, the peripheral portion of the stacked electrode assembly is thinner than the more inward portion thereof by the thickness of the positive electrode plates. For this reason, when vacuum-sealing the battery case, the battery case can deform in such a way as to be dented inward by the pressure reduction (i.e., in such a way as to form a step), and creases and warpage tend to form easily also at the peripheral portion of the stacked electrode assembly. By providing an overlapping portion for the second spacer as in the second aspect of the invention, insufficient thickness in the peripheral portion of the stacked electrode assembly is compensated, and thereby, the battery case is prevented from deforming in such a way as to be dented inward.

In the second aspect of the invention, it is desirable that the spacer be electrically insulative.

As already described above, it is desirable that the spacer be made of a material having insulative properties, such as rubber and resin. The use of rubber or resin allows the spacer to be formed into a desirable hardness, makes the processing easy, and moreover, enables formation of the spacers for the positive and negative electrodes integrally.

In the second aspect of the invention, it is desirable that the spacer have a Vickers hardness of from 100 HV to less than 200 HV.

The shape-retaining capability of the spacer can be sufficiently exhibited when the spacer has a Vickers hardness of 100 HV or greater, although it may depend on its shape and thickness. In addition, when the spacer has a Vickers hardness of less than 200 HV, the battery case can be prevented from being damaged by the corner portions or the like of the battery case during the vacuum-sealing because of excessive hardness, and moreover, the spacer can be easily fitted or mounted because it can be deformed to an appropriate degree.

### DESCRIPTION OF THE PREFERRED EMBODIMENTS

Hereinbelow, with reference to the drawings, the present invention is described in further detail based on certain embodiments and examples thereof. It should be construed, however, that the present invention is not limited to the following embodiments and examples, and various changes and modifications are possible without departing from the scope of the invention.

### Preparation of Positive Electrode

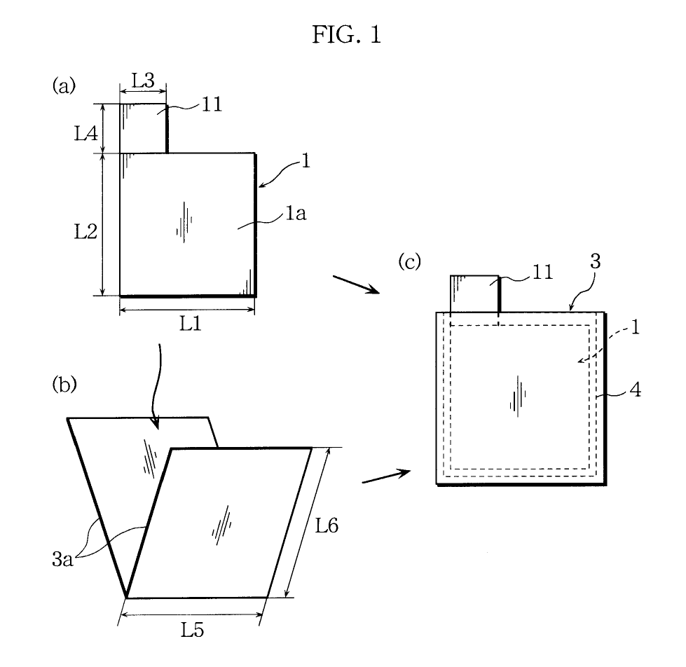

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector. Then, the material was dried to remove the solvent and compressed with rollers to a thickness of 0.1 mm. Thereafter, as illustrated in FIG. 1(a), it was cut so that a width L1=95 mm and a height L2=115 mm, to prepare a positive electrode plate 1 having a positive electrode active material layer 1a on each side. At this point, a positive electrode lead tab 11 was formed by allowing an active material uncoated portion, having a width L3=30 mm and a height L4=20 mm, to protrude from one end (the left end in FIG. 1(a)) of one side of the positive electrode plate 1 that extends along a width L1.

### Preparation of Negative Electrode

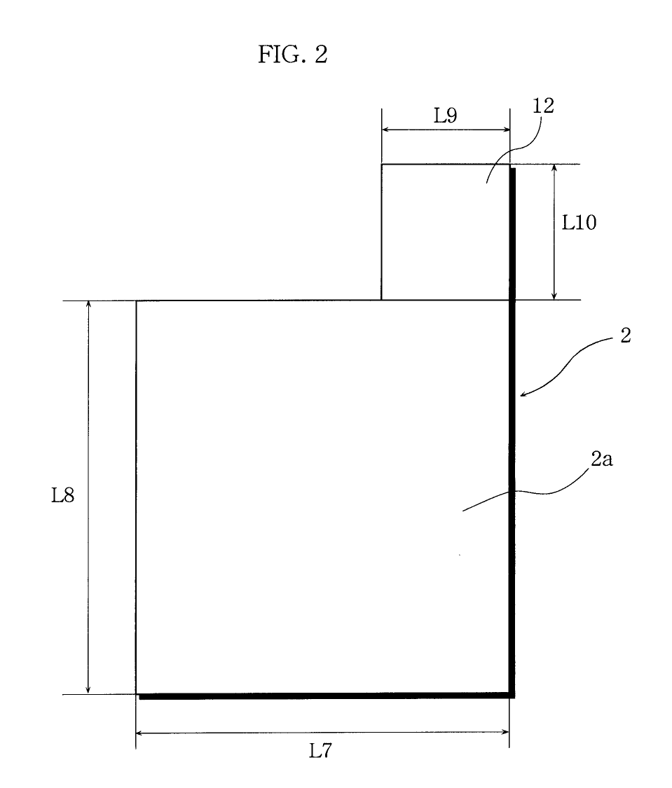

95 mass % of graphite powder as a negative electrode active material and 5 mass % of polyvinylidene fluoride as a binder agent were mixed with an NMP solution as a solvent to prepare a negative electrode slurry. Thereafter, the resultant negative electrode slurry was applied onto both sides of a copper foil (thickness: 10 μm) serving as a negative electrode current collector. Then, the material was dried to remove the solvent and compressed with rollers to a thickness of 0.08 mm. Thereafter, as illustrated in FIG. 2, it was cut so that a width L7=100 mm and a height L8=120 mm, to prepare a negative electrode plate 2 having a negative electrode active material layer 2a on each side. Here, a negative electrode lead tab 12 was formed by allowing an active material uncoated portion having a width L9=30 mm and a height L10=20 mm to protrude from one end (the right end in FIG. 2) of the negative electrode plate 2 that is opposite to the side end thereof at which the positive electrode lead tab 11 was formed, in one side of the negative electrode plate 2 that extends widthwise.

Preparation of Pouch-Type Separator in which the Positive Electrode Plate is Disposed

The positive electrode plate 1 was disposed between two square-shaped polypropylene (PP) separators 3a (thickness: 30 μm) each having a width L5=100 mm and a height L6=120 mm as illustrated in FIG. 1(b). Thereafter, as illustrated in FIG. 1(c), the peripheral portions of the separators 3a were thermally sealed at a sealing part 4, to prepare a pouch-type separator 3, in which the positive electrode plate 1 is accommodated.

### Preparation of Stacked Electrode Assembly

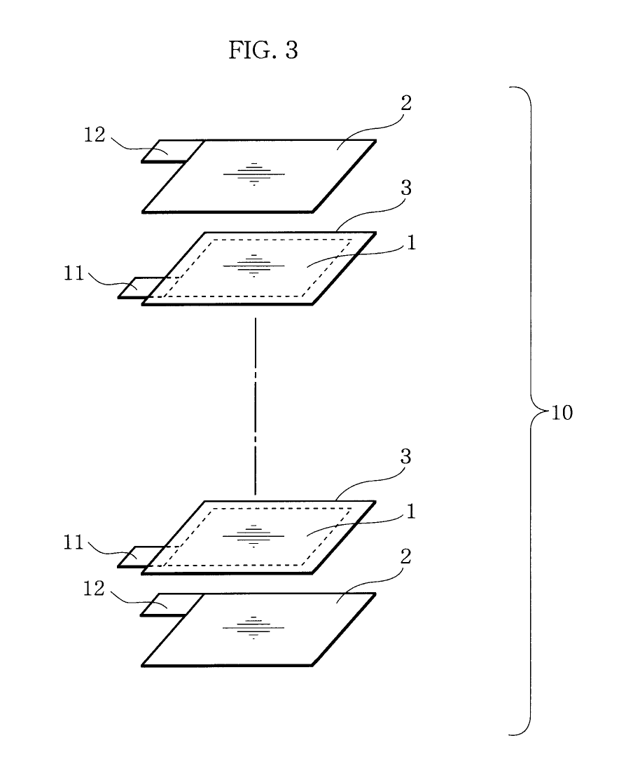

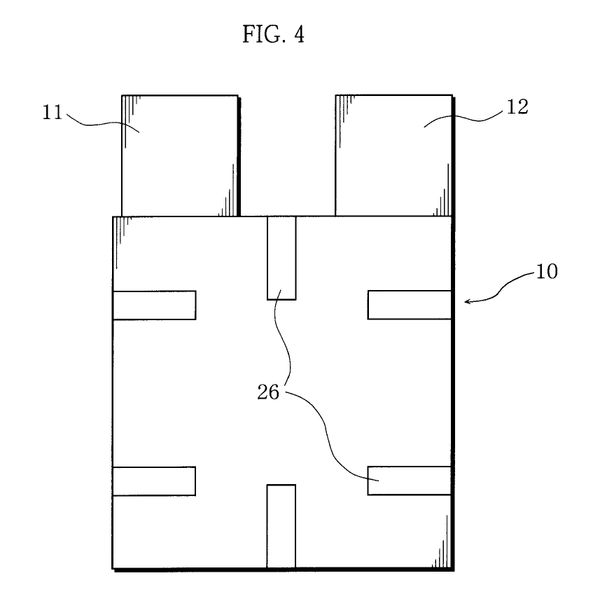

50 sheets of the pouch-type separators 3 in each of which the positive electrode plate 1 was disposed and 51 sheets of the negative electrode plates 2 were prepared, and the pouch-type separators 3 and the negative electrode plates 2 were alternately stacked one on the other, as illustrated in FIG. 3. Both top and bottom faces of the stack were the negative electrode plates 2. Subsequently, as illustrated in FIG. 4, the top and bottom faces of the stack were connected by insulating tapes 26 for retaining its shape. Thus, a stacked electrode assembly 10 was obtained.

### Welding of Current Collectors

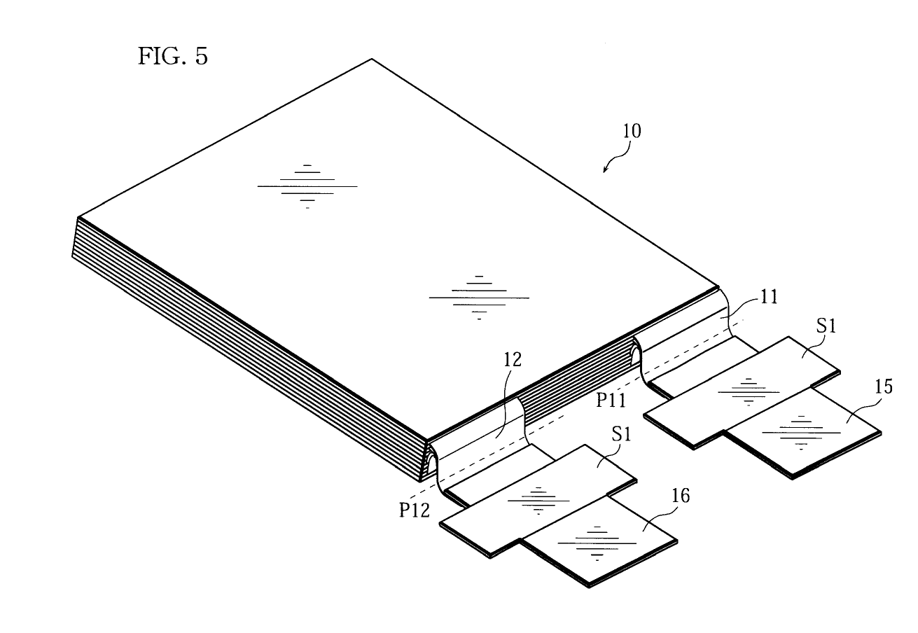

As illustrated in FIG. 5, a positive electrode current collector terminal 15 made of an aluminum plate having a width of 30 mm and a thickness of 0.5 mm and a negative electrode current collector terminal 16 made of a copper plate having a width of 30 mm and a thickness of 0.5 mm were welded respectively to the foremost ends of the positive electrode lead tabs 11 and the foremost ends of the negative electrode lead tabs 12 by ultrasonic welding.

It should be noted that reference symbol 51 in FIG. 5 and other drawings denotes a resin sealing material (adhesive material) formed so as to be firmly bonded to each of the positive and negative electrode current collector terminals 15 and 16 in a belt-like shape along a widthwise direction in order to ensure the hermeticity of a later-described battery case 18 when heat-sealing the battery case.

### Welding of Electrode Plates Lead Tabs

The stacked positive electrode lead tabs 11 are joined to each other ultrasonic welding and also the stacked negative electrode lead tabs 12 are joined to each other ultrasonic welding at respective locations between the positive and negative electrode current collector terminals 15, 16 and the positive and negative electrode plates 1, 2 (the positions P11 and P12 shown in FIG. 5), that is, at the locations in which only the positive and negative electrode lead tabs 11, 12 exist.

### Shaping of Current Collectors

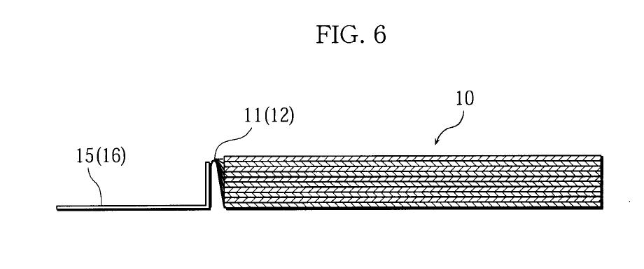

As illustrated in FIG. 6, the positive or negative electrode lead tabs 11 or 12 were bent in such a structure as to protrude from the respective electrode plates (the positive or negative electrode plates 1 or 2) while being folded at an intermediate location. The details are as follows. The stacked positive or negative electrode lead tabs 11 or 12 were bent firstly at a location where they protrude from the respective electrode plates (the positive or negative electrode plates 1 or 2) so as to be gathered (i.e., collected) toward one end (the upper end in FIG. 6) along the stacking direction. That is, the entirety of the stacked positive or negative electrode lead tabs 11 or 12 was bent firstly toward one end (the upper end in FIG. 6) at the location where they protrude from the respective electrode plates (the positive or negative electrode plates 1 or 2) in a substantially hook-like shape as viewed from side, so as to extend in a direction substantially perpendicular to the originally extending direction (i.e., so as to extend in a thickness direction). Next, the electrode lead tabs were bent 180 degrees backward (downward in FIG. 6) at the extending end (the upper end in FIG. 6). Subsequently, the joined positive or negative electrode current collector terminals 15 or 16 were again bent at the first bending position (the lower end in FIG. 6) in the perpendicular direction so as to extend in the originally extending direction (in a leftward direction in FIG. 6). Thus, the entirety of the positive or negative electrode lead tabs 11 or 12 was folded at an intermediate location of its protruding portion and shortened with respect to the extending direction, to form a folding structure. In this folding structure, the positive or negative electrode lead tabs 11, 12 are bent firstly at a location where they protrude from the respective electrode plates (the positive or negative electrode plates 1 or 2) so as to be gathered (i.e., collected) toward one end (the upper end in FIG. 6) along the stacking direction, and then bent 180 degrees backward (downward in FIG. 6) at the extending end (the upper end in FIG. 6). The just-mentioned one end (the upper end in FIG. 6) corresponds to the fold line side end. On the other hand, the positive or negative electrode lead tabs 11, 12 are again bent at the side end opposite the fold line side end in the perpendicular direction so as to protrude in the originally extending direction (in the leftward direction in FIG. 6). The just-mentioned side end opposite the fold line side end (the first bending position; the lower end in FIG. 6) corresponds to the open side end.

### Preparation of Spacer

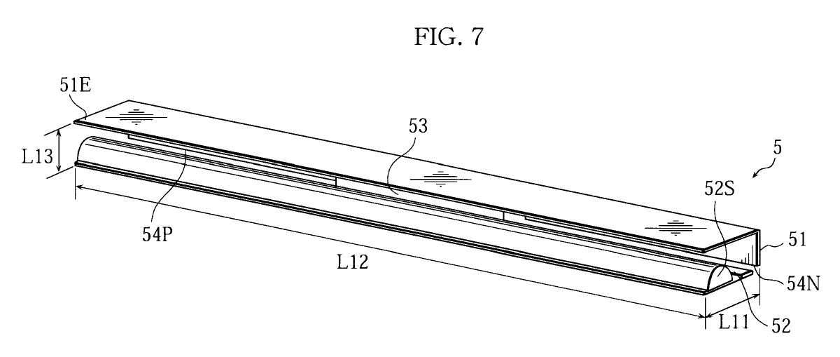

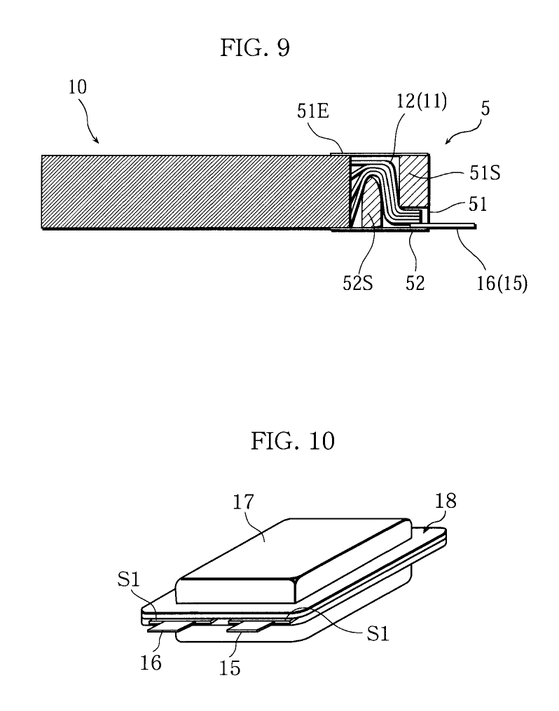

Polypropylene having a bending strength 35-55 MPa and a bending elastic modulus 897-1700 MPa according to the test method defined in JIS K 7171, Plastics—Determination of flexural properties, was molded to prepare an integral-type spacer 5 as shown in FIG. 7. As shown in the figure, the integral-type spacer 5 has a first cover portion 52 extending long in a substantially sheet shape and a second cover portion 51 having the same length as the first cover portion 52 and extending in a hook-like shape (in an L-shape) in cross section. The first cover portion 52 and one piece of the second cover portion 51 (the horizontal piece in FIG. 7) are opposed parallel to each other at a gap and are vertically connected by a rectangular connecting piece 53 at their central portion. They are formed integrally with each other so as to be one member as a whole and form a substantially angular C-shape in cross section having a length L11=15.0 mm, a width L12=100.0 mm, and a height L13=13.0 mm. The width of the connecting piece 53 is set to be slightly less than the space between the positive electrode current collector terminal 15 and the negative electrode current collector terminal 16. On both sides of the connecting piece 53, gaps are formed between the foremost edge of the other piece of the second cover portion 51 (the vertical portion in FIG. 7) and the first cover portion 52. Thereby, a positive electrode side slit 54P and a negative electrode side slit 54N for passing the positive electrode current collector terminal 15 and the negative electrode current collector terminal 16 therethrough are formed on both sides of the connecting piece 53. The one piece of the second cover portion 51 (the horizontal piece in FIG. 7) further extends to form an overlapping piece 51E. The overlapping piece 51E extends so as to overlap sufficiently with a 2.5 mm-width portion of the stacked electrode assembly 10 on the current collector side edge in which the positive electrode plates 1 do not exist. The first cover portion 52 also extends to substantially the same position as the extending end of the overlapping piece 51E. A first filling portion 52S having a solid semi-columnar shape and extending along a lateral direction L12 is integrally formed on the inner side of the foremost end of the first cover portion 52. On the inner side of the second cover portion 51, a second filling portion 51S having a solid prism shape and extending along a lateral direction L12 is formed so as to be integrally connected to both pieces (the horizontal piece and the vertical piece in FIG. 7) of the second cover portion 51 (see FIG. 9, not shown in FIG. 7). The Vickers hardness of the obtained integral-type spacer 5 was measured. It was found that the obtained integral-type spacer 5 had a Vickers hardness of 100 HV.

### Arrangement of the Spacer

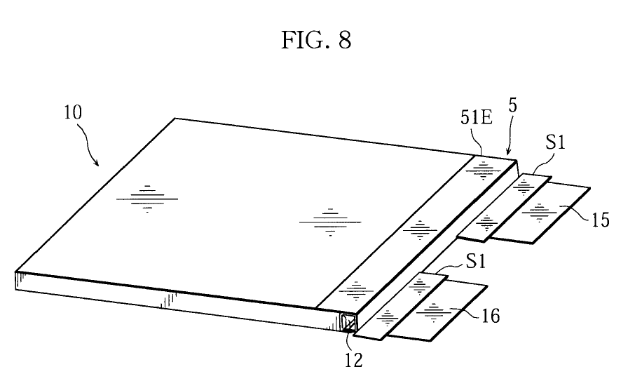

As illustrated in FIGS. 8 and 9, the integral-type spacer 5 was fitted to the current collector-side end of the stacked electrode assembly 10. At this time, the positive electrode current collector terminal 15 and the negative electrode current collector terminal 16 were passed through the positive electrode side slit 54P and the negative electrode side slit 54N, respectively. The overlapping piece 51E was overlaid from above onto the current collector-side edge of the stacked electrode assembly 10 in which the positive electrode plates 1 do not exist. The first filling portion 52S was pressed into a folded portion of the positive and negative electrode lead tabs 11 and 12 from below. Thereby, the current collector-side end of the stacked electrode assembly 10 and the positive and negative electrode lead tabs 11 and 12 were covered by the integral-type spacer 5. Thus, only the portion of each of the positive and electrode current collector terminals 15 and 16 on which the resin sealing material S1 adhered and the portion of each of the positive and negative electrode current collector terminals 15 and 16 that is further forward therefrom protrude outside from the integral-type spacer 5.

### Placing the Electrode Assembly in Battery Case

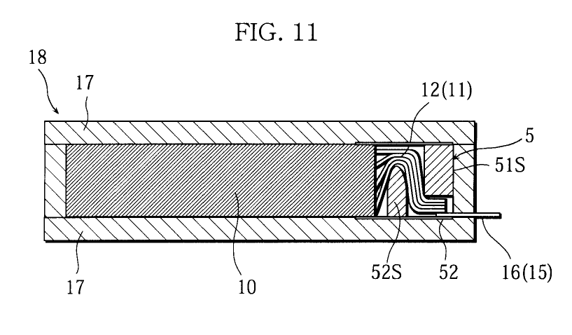

As illustrated in FIGS. 10 and 11, the above-described stacked electrode assembly 10 was inserted into a battery case 18 formed of laminate films 17, which had been formed in advance so that the stacked electrode assembly 10 could be placed therein. Then, one side of the battery case in which the positive electrode current collector terminal 15 and the negative electrode current collector terminal 16 were present was thermally bonded so that only the positive electrode current collector terminal 15 and the negative electrode current collector terminal 16 would protrude from the battery case 18, and two sides of the remaining three sides of the battery case were thermally bonded together.

### Filling Electrolyte Solution and Sealing the Battery Case

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case 18 from the remaining one side of the battery case that was not yet thermally bonded. Lastly, the one side that had not been thermally bonded was thermally bonded. Thus, a battery was prepared.

In the above-described process of filling the electrolyte solution and hermetical sealing the battery case, no crease or warpage in the battery case 18 was formed at the portion further forward than the positive and negative electrode lead tabs 11 and 12 (i.e., at the current collector-side end), at the current collector-side edge portion of the stacked electrode assembly 10, or at the folded portions of the positive and negative electrode lead tabs 11 and 12, even when the battery case 18 is evacuated and vacuum-sealed. Moreover, no misalignment was caused in the integral-type spacer 5.

### EXAMPLES

### Example 1

A stack type battery fabricated in the same manner as described in the foregoing embodiment was used as the stack type battery of this example.

The battery fabricated in this manner is hereinafter referred to as Battery A1 of the invention.

In the following examples and the drawings, parts and components that are or similar to those described in the foregoing embodiment and Example 1 above as well as in FIGS. 1 through 11 are denoted by like reference numerals and symbols, and no further details thereof are given unless necessary.

### Example 2

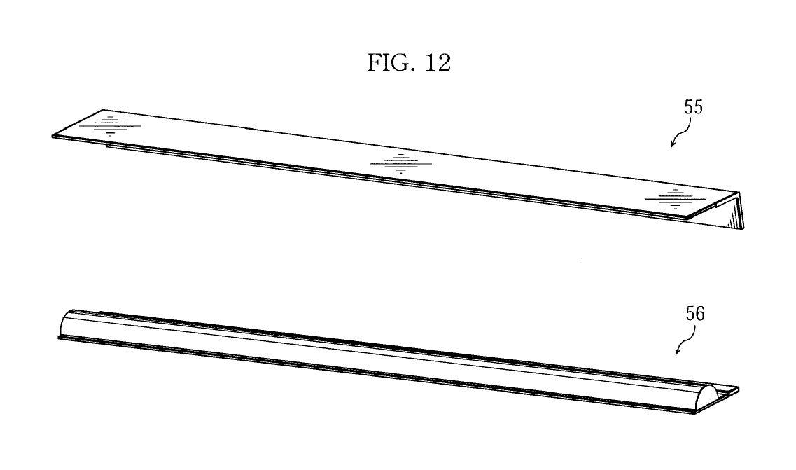

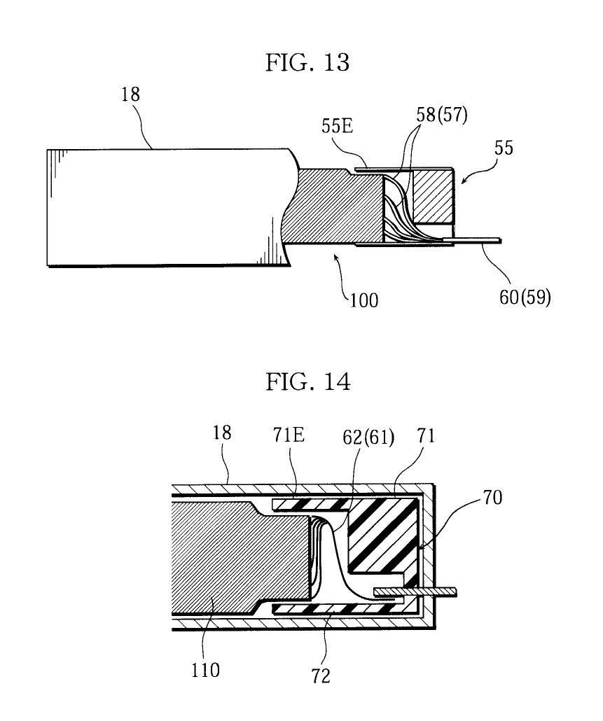

As illustrated in FIG. 12, a first spacer 56 and a second spacer 55 were individually formed so as to have the same configurations as the first cover portion 52 and the second cover portion 51, respectively, of the integral-type spacer 5 in Battery A1 of the invention. The first spacer 56 and the second spacer 55 are laterally long members having the same cross-sectional shape as each other. Needless to say, neither of the first spacer 56 and the second spacer 55 has a part that corresponds to the connecting piece 53 of the integral-type spacer 5 in Battery A1 of the invention. A stack type battery was fabricated in the same manner as the foregoing Battery A1 of the invention, except that the first spacer 56 and the second spacer 55 were individually disposed at the same locations as the first cover portion 52 and the second cover portion 51 were disposed in the integral-type spacer 5 of Battery A1 of the invention.

The battery fabricated in this manner is hereinafter referred to as Battery A2 of the invention.

In the just-described Battery A2 of the invention, it was observed that when the battery case 18 was vacuum-sealed in the process of filling the electrolyte solution and sealing the battery case, misalignment occurred between the first spacer 56 and the second spacer 55, causing small creases and slight warpage in the battery case 18. However, the first spacer 56 and the second spacer 55 prevented the battery case 18 from being forced into or dented at the portion (the current collector-side end) further forward than the positive and negative electrode lead tabs 11 and 12, the current collector-side edge of the stacked electrode assembly 10, and the folded portions of the positive and negative electrode lead tabs 11 and 12. As a result, substantially creases or warpage did not occur.

### Comparative Example 1

A stack type battery was fabricated in the same manner as the foregoing Battery A2 of the invention, except that no first spacer was provided.

The battery fabricated in this manner is hereinafter referred to as Comparative Battery Z1.

In Comparative Battery Z1, when the battery case 18 was vacuum-sealed in the process of filling the electrolyte solution and hermetically sealing the battery case, the battery case 18 was pressed into the open side end of the positive and negative electrode lead tabs 11 and 12 and dented inward, and consequently, substantial creases formed in the battery case 18. It was also observed that misalignment of the second spacer 55 occurred, and this also caused creases in the battery case 18.

Advantageous Effects obtained by Batteries A1 and A2 of the Invention

Each of the foregoing Batteries A1 and A2 has the following structure. The stacked electrode assembly 10 has 50 sheets of the positive electrode plates 1, 51 sheets of the negative electrode plates 2, and the pouch-type separators 3 interposed therebetween. The positive and negative electrode plate lead tabs 11 and 12 protruding from the respective electrode plates 1, 2 are joined respectively to the positive and negative electrode current collector terminals 15 and 16 so that a plurality of each of the positive and negative electrode plate lead tabs 11 and 12 are stacked and overlapped with one another. The stacked positive electrode plate lead tabs 11 and the negative electrode plate lead tabs 12 are joined respectively to one another at the respective locations between the positive and negative electrode current collector terminals 15 and 16 and the positive and negative electrode plates 1 and 2. The positive and negative electrode plate lead tabs 11 and 12 are folded at intermediate locations and protrude from the respective electrode plates 1 and 2. The battery case 18 having flexibility accommodates the stacked electrode assembly 10. The first cover portion 52 of the integral-type spacer 5 (in Battery A1) or the first spacer 56 (in Battery A2), each serving as the first spacer, is disposed between the battery case 18 and the open side end of the positive and negative electrode plate lead tabs 11 and 12, the open side end being located opposite the fold line side end and formed by folding back the electrode plate lead tabs at least one time.

With the above-described configurations of Batteries A1 and A2 of the invention, the first spacer (the first cover portion 52 of the integral-type spacer 5 or the first spacer 56) disposed between the battery case 18 and the open side end of the positive and negative electrode plate lead tabs 11 and 12 prevents the battery case 18 from being forced into the open side ends of the positive and negative electrode plate lead tabs 11 and 12 that have been formed by folding them because of the pressure reduction in the vacuum-sealing of the battery case 18, so the battery case 18 is unable to be forced into the open side ends of the positive and negative electrode plate lead tabs 11 and 12. As a result, the battery case 18 cannot be dented inward at that portion. Therefore, formation of creases and warpage is inhibited.

In addition, the formation of creases or warpage in the battery case 18 can be inhibited effectively by the simple structure of providing the first spacer (the first cover portion 52 of the integral-type spacer 5 or the first spacer 56) between the battery case 18 and the open side ends of the positive and negative electrode plate lead tabs 11 and 12. This means that the battery structure is not made more complicated.

The first spacer (the first cover portion 52 of the integral-type spacer 5 or the first spacer 56) is disposed so as to be inserted between the open side ends of the positive and negative electrode plate lead tabs 11 and 12, the open side ends being formed by folding them. A gap can be easily formed between the open side ends of the positive and negative electrode plate lead tabs 11 and 12 when they are forced open. However, the above-described configurations make it possible to inhibit formation of the gap at the folded portion more effectively because the first cover portion 52 of the integral-type spacer 5 or the first spacer 56, more particularly the first filling portion 52S, is inserted in advance. In other words, the gap that can be formed at the open side ends of the positive and negative electrode plate lead tabs 11 and 12 is plugged (i.e., filled up) in advance by the first cover portion 52 of the integral-type spacer 5 or the first spacer 56 (the first filling portion 52S), so that the formation of the gap is inhibited more effectively.

The second cover portion 51 of the integral-type spacer 5 or the second spacer 55, each serving as the second spacer, is disposed opposite the first spacer (the first cover portion 52 of the integral-type spacer 5 or the first spacer 56) across the positive and negative electrode lead tabs 11 and 12. The location opposite the first spacer (the first cover portion 52 of the integral-type spacer 5 or the first spacer 56) across the positive and negative electrode lead tabs 11 and 12 is a location serving as the portion from which the current collectors protrude, and a location in which a gap can be particularly easily formed. Therefore, by providing the second spacer (the second cover portion 51 of the integral-type spacer 5 or the second spacer 55) at this location, formation of creases or warpage in the battery case 18 can be inhibited more effectively.

In addition, the opening of the positive and negative electrode lead tabs 11 and 12 is prevented by not only by the first spacer (the first cover portion 52 of the integral-type spacer 5 or the first spacer 56) but also by the second spacer (the second cover portion 51 of the integral-type spacer 5 or the second spacer 55) from the opposite side. As a result, the creases or warpage of the battery case 18 can be inhibited even more effectively. For example, as illustrated in FIG. 11, the positive and negative electrode lead tabs 11 and 12 are sandwiched between the first filling portion 52S of the first cover portion 52, which serves as the first spacer, and the second filling portion 51S of the second cover portion 51, which serves as the second spacer. Thus, even if the positive and negative electrode lead tabs 11 and 12 are attempted to force open, there is substantially no room for opening the positive and negative electrode lead tabs 11 and 12 because the second filling portion 51S of the second cover portion 51 is disposed in the opening direction, making the electrode lead tabs difficult to be forced open. In other words, the opening of the positive and negative electrode lead tabs 11 and 12 is prevented mainly by the first spacer and additionally by the second spacer.

The second spacer (the second cover portion 51 of the integral-type spacer 5 or the second spacer 55) has an overlapping portion 51E overlapping with the peripheral portion of the stacked electrode assembly 10 for compensating the thickness of the stacked electrode assembly. In the stacked electrode assembly, the positive electrode plates 1 (95 mm×115 mm) are formed in smaller dimensions than the negative electrode plates 2 (100 mm×120 mm), so the positive electrode plates 1 do not exist in the peripheral portion of the stacked electrode assembly 10. Thus, the peripheral portion of the stacked electrode assembly 10 is thinner than the more inward portion thereof by the thickness of the positive electrode plates 1. For this reason, when vacuum-sealing the battery case 18, the battery case 18 can deform in such a way as to be dented inward by the pressure reduction (i.e., in such a way as to form a step), and consequently, creases and warpage tend to form easily at the peripheral portion of the stacked electrode assembly 10. By providing the overlapping portion 51E for the second spacer (the second cover portion 51 of the integral-type spacer 5 or the second spacer 55), insufficient thickness in the peripheral portion of the stacked electrode assembly 10 is compensated, and thereby, the battery case 18 is prevented from deforming in such a way as to be dented inward.

In addition, the integral-type spacer 5 in the foregoing Battery A1 of the invention has such a structure that the first cover portion 52, which corresponds to the first spacer, and the second cover portion 51, which corresponds to the second spacer, are integrated with each other. When the first spacer and the second spacer are separated and disposed individually, the positions of the first spacer and the second spacer tend to be misaligned easily due to the internal pressure changes caused by vacuum-sealing and the shock caused by dropping. This misalignment is likely to be a cause of the creases or warpage of the battery case. However, such misalignment does not occur easily in the structure of the integral-type spacer 5 in the foregoing Battery A1 of the invention because the first spacer (the first cover portion 52) and the second spacer (the second cover portion 51) are integrated with each other.

In addition, both the integral-type spacer 5 in the Battery A1 of the invention and the second spacer 55 and the first spacer 56 in the Battery A2 of the invention is made of polypropylene and thus electrically insulative. The spacer may be made of any material regardless of being an insulator or a conductor as long as the material has the required shape-retaining capability. However, since the integral-type spacer 5, the second spacer 55, and the first spacer 56 are electrically insulative, it is unnecessary to insulate a spacer at the position corresponding to the positive electrode and a spacer at the position corresponding to the positive electrode from each other. As a result, the battery structure is simplified correspondingly. Moreover, the spacers corresponding to the respective electrodes are integrated with each other. Furthermore, the integral-type spacer 5, the second spacer 55, and the first spacer 56 can be easily provided with a desired hardness because a polypropylene resin is used.

In addition, the integral-type spacer 5 in the Battery A1 of the invention as well as the second spacer 55 and the first spacer 56 in the Battery A2 of the invention has a Vickers hardness of 100 HV. Therefore, the integral-type spacer 5 is allowed to exhibit sufficient shape-retaining capability, and the battery case 18 can be prevented from being damaged by the corner portions or the like of the battery case 18 during the vacuum-sealing because of excessive hardness. Moreover, the spacers can be easily fitted or mounted because the spacers can be deformed to an appropriate degree. In particular, since the first spacer and the second spacer are integrated with each other in the integral-type spacer 5, the positive and negative electrode current collector terminals 15 and 16 need to be fitted to the current collector-side end of the stacked electrode assembly 10 so as to pass through the positive and negative electrode side slits 54P and 54N respectively and to be sandwiched from above and below. In this process, if the deformability of the integral-type spacer 5 is insufficient, the fitting or mounting of the spacer tends to become difficult. For this reason, it is especially effective that the spacer have a Vickers hardness of 100 HV in this case.

### Example 3

A stack type battery was fabricated in the same manner as the foregoing Battery A2 of the invention, except that positive and negative electrode lead tabs 57 and 58 did not employ the two-stage connection structure, i.e., the positive and negative electrode lead tabs 57 and 58 were connected to positive and negative electrode current collector terminals 59 and 60 without being bent, and that the first spacer was not provided.

The battery fabricated in this manner is hereinafter referred to as Battery A3 of the invention.

In the just-described Battery A3 of the invention, it was observed that when the battery case 18 was vacuum-sealed in the process of filling the electrolyte solution and sealing the battery case, misalignment of the second spacer 55 occurred, causing small creases and slight warpage in the battery case 18. However, the second spacer 55 prevented the battery case 18 from being forced into or dented at the portion (the current collector-side end) further forward than the positive and negative electrode lead tabs 57 and 58 and the current collector-side edge of the stacked electrode assembly 100. As a result, substantially creases or warpage did not occur. Needless to say, since no folded portion of the positive and negative electrode lead tabs 57 and 58 exist in Battery A3 of the invention, it is inherently impossible for the battery case 18 to be forced into such a location.

Advantageous Effects obtained by Battery A3 of the Invention

The foregoing Battery A3 has the following structure. The stacked electrode assembly 100 has 50 sheets of the positive electrode plates, 51 sheets of the negative electrode plates, and the pouch-type separators 3 interposed therebetween. The positive and negative electrode plate lead tabs 57 and 58 protruding from the respective electrode plates are joined respectively to the positive and negative electrode current collector terminals 59 and 60 so that a plurality of each of the positive and negative electrode plate lead tabs 11 and 12 are stacked and overlapped with one another. The battery case 18 having flexibility accommodates the stacked electrode assembly 100. The second spacer 55 is disposed between the battery case 18 and the positive and negative electrode plate lead tabs 57 and 58. The second spacer 55 has an overlapping portion 55E overlapping with the peripheral portion of the stacked electrode assembly 100 for compensating the thickness of the stacked electrode assembly 100.

With the configuration of the Battery 3 of the invention, the second spacer 55 is disposed between the battery case 18 and the positive and negative electrode plate lead tabs 57 and 58. As a result, the battery case 18 is prevented from being dented inward, and thereby, formation of creases or warpage in the battery case 18 is inhibited. Moreover, since the second spacer 55 has the overlapping portion 55E, formation of the creases or warpage of the battery case 18 is prevented also at the peripheral portion of the stacked electrode assembly 100.

In the stacked electrode assembly 100, the positive electrode plates (95 mm×115 mm) are formed in smaller dimensions than the negative electrode plates (100 mm×120 mm), so the positive electrode plates do not exist in the peripheral portion of the stacked electrode assembly 100. Thus, the peripheral portion of the stacked electrode assembly 100 is thinner than the more inward portion thereof by the thickness of the positive electrode plates. For this reason, when vacuum-sealing the battery case 18, the battery case 18 can deform in such a way as to be dented inward by the pressure reduction (i.e., in such a way as to form a step), and consequently, creases and warpage tend to form easily at the peripheral portion of the stacked electrode assembly 100. Here, in the Battery A3 of the invention, the overlapping portion 55E is provided for the second spacer 55, insufficient thickness in the peripheral portion of the stacked electrode assembly 100 is compensated, and thereby, the battery case 18 is prevented from deforming in such a way as to be dented inward.

In the Battery A3 of the invention, the second spacer 55 is made of polypropylene and thus electrically insulative. In addition, the second spacer 55 can be easily provided with a desired hardness because a polypropylene resin is used.

In addition, in the Battery A3 of the invention, the second spacer 55 has a Vickers hardness of 100 HV. Therefore, the integral-type spacer 5 is allowed to exhibit sufficient shape-retaining capability, and the battery case 18 can be prevented from being damaged by the corner portions or the like of the battery case 18 during the vacuum-sealing because of excessive hardness. Moreover, the spacer can be deformed to an appropriate degree, so the fitting or mounting can be done easily.

### Other Embodiments

(1) In the foregoing Batteries A1 and A2 of the invention, the first spacer (the first cover portion 52 of the integral-type spacer 5 or the first spacer 56), more particularly, the first filling portion 52S is disposed so as to be inserted in advance between the open side ends formed by folding the positive and negative electrode lead tab 11 and 12. However, it is sufficient that the first spacer be disposed between the battery case and an open side end of the electrode plate lead tabs. For example, as illustrated in FIG. 14, the first spacer may have a structure such as to cover the open side ends from outside without being inserted between the open side ends of the positive and negative electrode lead tabs 61 and 62. In the example shown in the figure, a flat plate-shaped first cover portion 72 having shape-retaining capability is disposed between the battery case 18 and the open-side of the positive and negative electrode lead tab 61 or 62 so as to cover the open side end from outside. The first cover portion 72 is integrally formed with a second cover portion 71 having the same structure as the second cover portion 51 of the integral-type spacer 5 in the foregoing Battery A1 of the invention, so that they, as a whole, form an integral-type spacer 70. With this structure, the open side end of the positive and negative electrode lead tab 61 or 62 is plugged by being covered by the flat-shaped first cover portion 72, and as a result, the battery case 18 is prevented from being forced therein. In addition, the flat-shaped first cover portion 72, as well as an overlapping portion 71E of the second cover portion 71, extends to the position overlapping the peripheral portion of the stacked electrode assembly 110 so as to sandwich the peripheral portion of the stacked electrode assembly 110 from above and below together with the overlapping portion 71E of the second cover portion 71, so that insufficient thickness of the stacked electrode assembly 110 resulting from the lack of the positive electrode plates in the peripheral portion can be compensated.

(2) In the foregoing Battery A1 of the invention, the integral-type spacer 5 has a structure in which the first cover portion 52, which corresponds to the first spacer and the second cover portion 51, which corresponds to the second spacer, are integrally formed by integral formation. However, in place of this structure, it is possible that the first spacer and the second spacer may be formed individually and then they may be integrated by joining them to each other by an appropriate method such as welding, molding, and screw-fastening. In this structure, the first cover portion and the second cover portion may be individually disposed to the stacked electrode assembly and thereafter integrally formed. This makes the placing of the spacer more easy, especially when the hardness of the spacer is greater. Furthermore, portions of the spacer, such as the second filling portion and the first filling portion, may be individually formed, and thereafter the portions may be joined to and integrated with the main part by an appropriate method.

(3) The positive electrode active material is not limited to lithium cobalt oxide. Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.

(4) Other than the graphite such as natural graphite and artificial graphite, various materials may be employed as the negative electrode active material as long as the material is capable of intercalating and deintercalating lithium ions. Examples include coke, tin oxides, metallic lithium, silicon, and mixtures thereof

(5) The electrolyte is not limited to that shown in the examples above, and various other substances may be used. Examples of the lithium salt include LiBF₄, LiPF₆, LiN(SO₂CF₃)₂, LiN(SO₂C₂F₅)₂, and LiPF_{6-X}(CₙF₂ₙ₊₁)_{X} (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte solution. The types of the solvents are not particularly limited to EC and MEC mentioned above. Examples of preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

The present invention is suitably applied to, for example, power sources for high-power applications, such as backup power sources and power sources for the motive power incorporated in robots and electric automobiles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A stack type battery comprising:
a stacked electrode assembly having a plurality of positive electrode plates, a plurality of negative electrode plates, and a separator interposed therebetween, the positive electrode plates and the negative electrode plates being alternately stacked on one another;
a plurality of electrode plate lead tabs protruding from the respective electrode plates, the electrode plate lead tabs stacked and overlapped with one another and joined respectively to positive and negative electrode current collector terminals,
the stacked electrode plate lead tabs being joined to one another at a location between the current collector terminals and the electrode plates, and
the electrode plate lead tabs being folded at an intermediate location and protruding from the respective electrode plates;
a battery case having flexibility and accommodating the stacked electrode assembly therein; and
a first spacer disposed between the battery case and an open side end of the electrode plate lead tabs, the open side end being located opposite a fold line side end and formed by folding back the electrode plate lead tabs at least one time.

2. The stack type battery according to claim 1, wherein the first spacer is disposed so as to be inserted between the open side ends of the electrode plate lead tabs.

3. The stack type battery according to claim 1, further comprising a second spacer disposed opposite the first spacer across the electrode plate lead tabs.

4. The stack type battery according to claim 2, further comprising a second spacer disposed opposite the first spacer across the electrode plate lead tabs.

5. The stack type battery according to claim 3, the second spacer has an overlapping portion overlapping with a peripheral portion of the stacked electrode assembly for compensating a thickness of the stacked electrode assembly.

6. The stack type battery according to claim 4, the second spacer has an overlapping portion overlapping with a peripheral portion of the stacked electrode assembly for compensating a thickness of the stacked electrode assembly.

7. The stack type battery according to claim 3, wherein the first spacer and the second spacer are integrated with each other.

8. The stack type battery according to claim 5, wherein the first spacer and the second spacer are integrated with each other.

9. The stack type battery according to claim 1, wherein the first spacer is electrically insulative.

10. The stack type battery according to claim 3, wherein the first spacer and/or the second spacer is/are electrically insulative.

11. The stack type battery according to claim 1, wherein the spacer or the spacers has/have a Vickers hardness of from 100 HV to less than 200 HV.

12. The stack type battery according to claim 7, wherein the spacer or the spacers has/have a Vickers hardness of from 100 HV to less than 200 HV.

13. A stack type battery comprising:
a stacked electrode assembly having a plurality of positive electrode plates, a plurality of negative electrode plates, and a separator interposed therebetween, the positive electrode plates and the negative electrode plates being alternately stacked on one another;
a plurality of electrode plate lead tabs protruding from the respective electrode plates, the electrode plate lead tabs stacked and overlapped with one another and joined respectively to positive and negative electrode current collector terminals,
a battery case having flexibility and accommodating the stacked electrode assembly therein; and
a spacer disposed between the electrode plate lead tabs and the battery case,
the spacer having an overlapping portion overlapping with a peripheral portion of the stacked electrode assembly for compensating a thickness of the stacked electrode assembly.

14. The stack type battery according to claim 13, wherein the spacer is electrically insulative.

15. The stack type battery according to claim 13, wherein the spacer has a Vickers hardness of from 100 HV to less than 200 HV.

16. The stack type battery according to claim 14, wherein the spacer has a Vickers hardness of from 100 HV to less than 200 HV.
